(19) United States
(12) Patent Application Publication
(10) Pub. No.: US 2013/0047683 A1
(43) Pub. Date: Feb. 28, 2013

(54) SYSTEM AND METHOD FOR SECURE PERSONAL ITEM STORAGE IN TRIATHLON TRANSITION AREAS

(71) Applicant: Alexander Arrow, Menlo Park, CA (US)

(72) Inventor: Alexander Arrow, Menlo Park, CA (US)

(21) Appl. No.: 13/571,176

(22) Filed: Aug. 9, 2012

Related U.S. Application Data
(60) Provisional application No. 61/521,532, filed on Aug. 9, 2011.

(51) Int. Cl. E05B 65/52; B65D 55/02

(52) U.S. Cl. 70/63; 70/78

(57) ABSTRACT

Embodiments are described for assisting an athlete in securely storing personal items such as keys, a smartphone, a camera, and the like in an outdoor triathlon transition area while he/she competes in the race. The locker is configured to lock the personal items securely with a combination or key, and in one embodiment, the locker may be additionally lockable to a triathlon transition area horizontal bicycle racking bar, and may be poseable from a position/orientation perspective relative to the racking bar. In one embodiment, the locker may be configured to have a watertight enclosure.

### RELATED APPLICATION DATA

The present application claims the benefit under 35 U.S.C. §119 to U.S. Provisional Application Ser. No. 61/521,532, filed Aug. 9, 2011. The foregoing application is hereby incorporated by reference into the present application in its entirety.

### FIELD OF THE INVENTION

The present invention relates generally to container systems, and specifically to technologies for triathletes to securely store small valuable items such as keys, cell phones, and cameras in the unique environment of a triathlon transition area.

### BACKGROUND

Outdoor triathlon events impose a security dilemma on every triathlete who competes in them, because of what is known as the triathlon “transition area”, an open-air temporarily fenced-off converted parking lot or grassy field that is utilized by the athletes to switch sports during the event—from swimming to cycling, and from cycling to running. The security issue is related to the fact that most triathletes need a place to put their car keys, smart phones, and other personal items in the transition area, and there typically is no secure option. In other words, while the athlete is competing in a swim, cycle circuit, or run, his personal items typically are sitting in the transition area without adequate security. Referring to FIG. 1A, a typical triathlon transition area (2) is depicted having mounted horizontal bars (4) that function as bicycle racks. An athlete is shown (6) arranging his personal items near his bicycle, which may include his bicycle helmet, running shoes, a towel, and various personal items (such as his cellphone, camera, keys, and the like) that he probably wishes he could store securely in the transition area. As is typical convention, one athlete has racked his bicycle and left his personal items (8) in his transition area spot unattended.

Referring to FIG. 1B, the horizontal bar (4) for racking bicycles (10) in this depiction of a transition area (2) is a bamboo rod with a substantially circular cross section. FIG. 1C depicts a particularly busy transition area (2) with a metallic horizontal bicycle racking bar (4) having a substantially circular cross section. One can see that many athletes have left their personal items unattended (8) in the transition area.

Referring to FIG. 1D, a closer view of another transition area (2) is depicted, with a bike racking bar (4) that has a substantially rectangular cross section in this instance. The spacing between bicycles (10) is quite minimal, with each athlete only having two or three feet to rack his bike (10) and store his personal items (8). FIG. 1E shows a less-crowded view depicting, among other things, the horizontal bike racking bar (4) that has a substantially rectangular cross section. FIG. 1F also shows a less-crowded view of a transition area (2) having a horizontal bike racking bar (4) that has a substantially circular cross sectional shape.

There are conventional technologies that may be utilized to assist in addressing the personal item security problem, but none are well suited for the triathlete's needs in the transition area. For example, referring to FIG. 2, a conventional locker room having a panel of lockers (12) may be well suited for a gymnasium environment where they may be fixedly attached to the walls of the locker room, but it is not well suited for the transition area, wherein the athletes are distributed all over the area and need space for their bicycles and other gear, and wherein there are no walls or other permanent structures to which a locker room style panel of lockers (12) may be attached. Referring to FIG. 3, a cable type lock (14) may be useful in securing a bicycle to the horizontal bar (4) in the transition area, but such a locking configuration is hardly going to be effective in securing an athlete's camera or other personal items. Referring to FIGS. 4 and 5, small safes (16) and vaults (18) are available, but generally are not well configured for transport by the athlete to the event, and are not configured to be mounted to a structure at the event, such as a bicycle racking structure. Referring to FIGS. 6A and 6B, a small metallic enclosure (20) which is lockably coupled to a cable/lid/lock assembly (22) may be useful for storing very small items, such as keys and a bit of cash as shown (24), but such a configuration is not well suited for storing valuable items regularly used by triathletes in their transition area, such as cell phones or smart phones (44), as shown in FIG. 9A, a wallet (36), as shown in FIG. 9B, a camera (42), as shown in FIG. 9C (picture taking is popular in the moments before a triathlon starts and just after each athlete finishes, leading triathletes to bring their digital cameras with them on the day of the event to the transition area), medicine (40), such as pain reliever or an lung inhaler (a medicine example is shown in FIG. 9D), and sunscreen (38), as shown in FIG. 9E. Similarly, the configurations of FIG. 7 and FIG. 8, each of which is configured for hiding extra keys near a home, for example, are not well suited for securing items such as those depicted in FIGS. 9A-9E in a triathlon transition area. The variation depicted in FIG. 7 has a housing (26) and lockable/removable door (28) that define a small enclosure large enough for small items such as keys (24). The variation depicted in FIG. 8 has a similar enclosure defined by a housing (32) and a swinging locking door (34). A movable locking member (30) may be used to lock the housing to a structure small enough to fit through the member (30), but neither of the housings (26, 32) are configured to hold the kinds of items that are of interest to the triathlete in the transition area, and neither has the ability to be positioned and/or oriented in a specific pose relative to a bicycle rack tube that may be helpful to the triathlete.

As described above, items such as those depicted in FIGS. 9A-9E typically are vulnerable to theft, and this vulnerability continues from before the event, during the event, and during the half hour or so after the athlete completes the course, a time that is usually spent away from the transition area, in food lines or watching an awards ceremony. The risk of theft is heightened in lengthy triathlons or those with heavy amateur participation, because the event staff often begins disassembling the fencing around the Transition Area before all the athletes have completed the race course. Even when event staff monitor the transition area exits and check wrist band numbers to deter bicycle theft, theft of small items like cameras is difficult to prevent. With the popularity of triathlon on the rise, events are getting larger. Several thousand athletes may compete in a single event (Wildflower®, Oceanside 70.3®, Escape from Alcatraz®, etc.). Larger events mean larger transition areas, such as the one shown in FIG. 1C, that are increasingly vulnerable to petty theft.

There is a need for a convenient, secure, simple way to store valuable items such as car keys, cell phones, and digital cameras in triathlon transition areas.

### BRIEF DESCRIPTION OF THE DRAWINGS

FIGS. 1A-1F illustrate various aspects of triathlon transition areas.

FIG. 2 illustrates a conventional locker panel configuration.

FIG. 3 illustrates a conventional cable type bicycle lock configuration.

FIGS. 4 and 5 illustrate conventional small safe or vault configurations.

FIGS. 6A-8 illustrate conventional locking systems for particularly small items such as keys.

FIGS. 9A-9E illustrate various personal items that a triathlete may want to securely store in a triathlon transition area.

FIG. 10A illustrates one embodiment of the present invention wherein a locker is coupled to a horizontal bicycle racking bar in a triathlon transition area.

FIG. 10B illustrates another embodiment of the present invention wherein two lockers are coupled to a horizontal bicycle racking bar in a triathlon transition area.

FIG. 10C illustrates one embodiment of the present invention wherein a multi-compartment locker is coupled to a horizontal bicycle racking bar in a triathlon transition area.

FIG. 11 illustrates one embodiment of the present invention wherein a locker is coupled to a horizontal bicycle racking bar in a triathlon transition area.

FIG. 12 illustrates one embodiment of the present invention wherein a locker is coupled to a horizontal bicycle racking bar in a triathlon transition area.

FIG. 13 illustrates a ratchet coupler.

FIG. 14 illustrates a handcuff-style coupling configuration.

FIG. 15 illustrates one embodiment of the present invention wherein a locker is coupled to a horizontal bicycle racking bar in a triathlon transition area.

FIG. 16A illustrates a clamp type bar coupler.

FIG. 16B illustrates one embodiment of the present invention wherein a locker is coupled to a horizontal bicycle racking bar in a triathlon transition area.

FIG. 17A illustrates a multi-element articulating assembly.

FIG. 17B illustrates one embodiment of the present invention wherein a locker is coupled to a horizontal bicycle racking bar in a triathlon transition area.

FIG. 18A illustrates one embodiment of the present invention wherein a locker is coupled to a horizontal bicycle racking bar in a triathlon transition area with a jointed coupling configuration.

FIG. 18B illustrates one embodiment of the present invention wherein a locker is coupled to a horizontal bicycle racking bar in a triathlon transition area with a jointed coupling configuration.

FIG. 19A illustrates one embodiment of the present invention wherein a locker is coupled to a horizontal bicycle racking bar in a triathlon transition area with a poseable flex coupling configuration.

FIG. 19B illustrates one embodiment of the present invention wherein a locker is coupled to a horizontal bicycle racking bar in a triathlon transition area with a poseable flex coupling configuration.

FIG. 20A illustrates one embodiment of the present invention wherein a locker is coupled to a horizontal bicycle racking bar in a triathlon transition area with a poseable jointed coupling configuration.

FIG. 20B illustrates one embodiment of the present invention wherein a locker is coupled to a horizontal bicycle racking bar in a triathlon transition area with a poseable jointed coupling configuration.

FIG. 21A illustrates one embodiment of the present invention wherein a multi-compartment locker is coupled to a horizontal bicycle racking bar in a triathlon transition area.

FIG. 21B illustrates one embodiment of the present invention wherein a multi-compartment locker is coupled to a horizontal bicycle racking bar in a triathlon transition area.

FIG. 21C illustrates one embodiment of the present invention wherein a multi-compartment locker is coupled to a horizontal bicycle racking bar in a triathlon transition area.

FIG. 22 illustrates one embodiment of a configuration for utilizing a triathlon transition area locker.

FIG. 23 illustrates one embodiment of a configuration for utilizing a triathlon transition area locker.

FIG. 24 illustrates one embodiment of a configuration for utilizing a triathlon transition area locker.

FIGS. 25A-25C illustrate one embodiment of a single-compartment locker which may be coupled to a horizontal bicycle racking bar in a triathlon transition area.

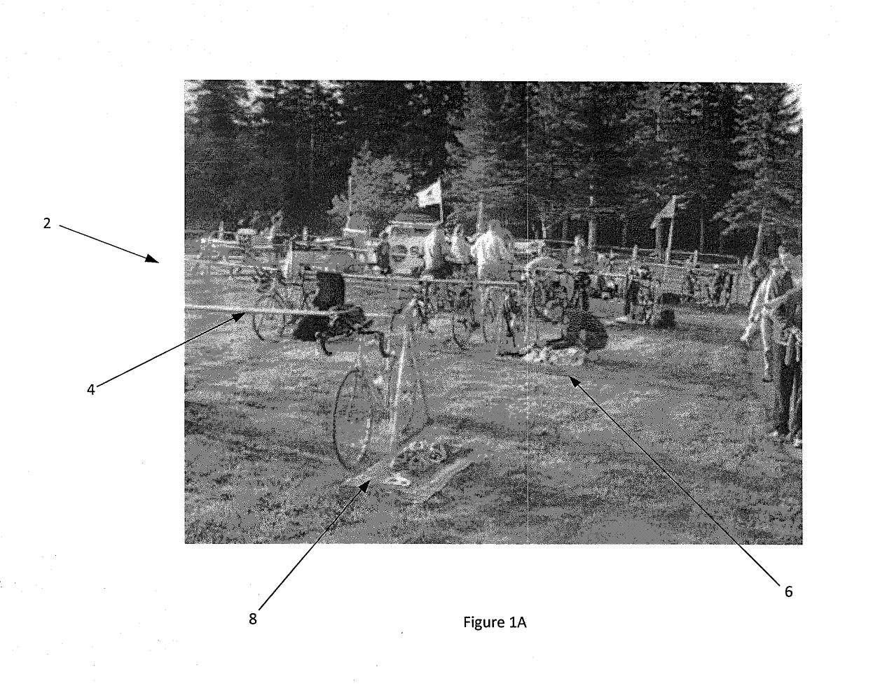

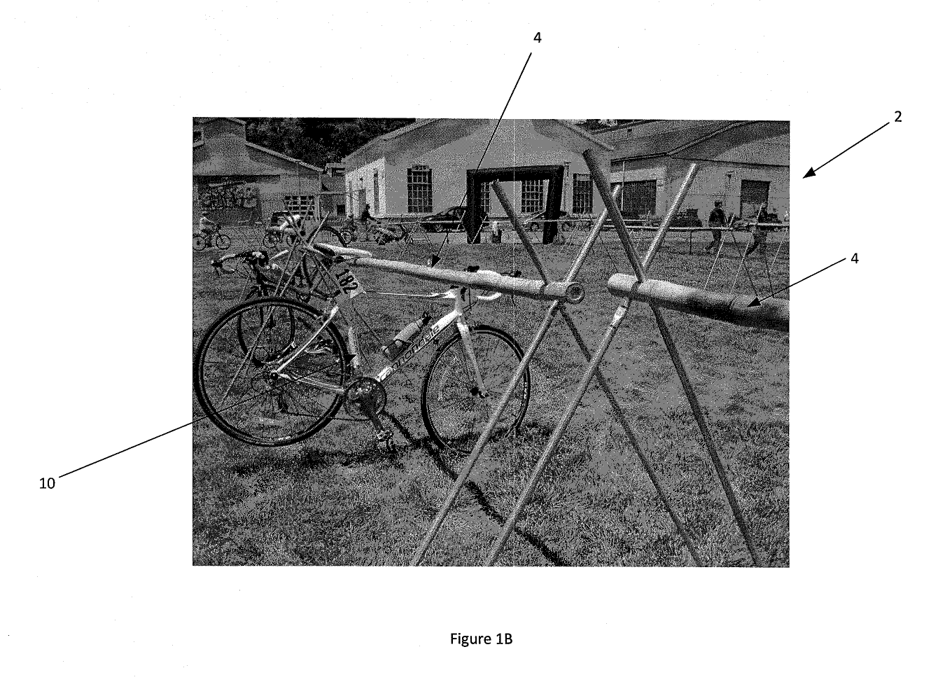

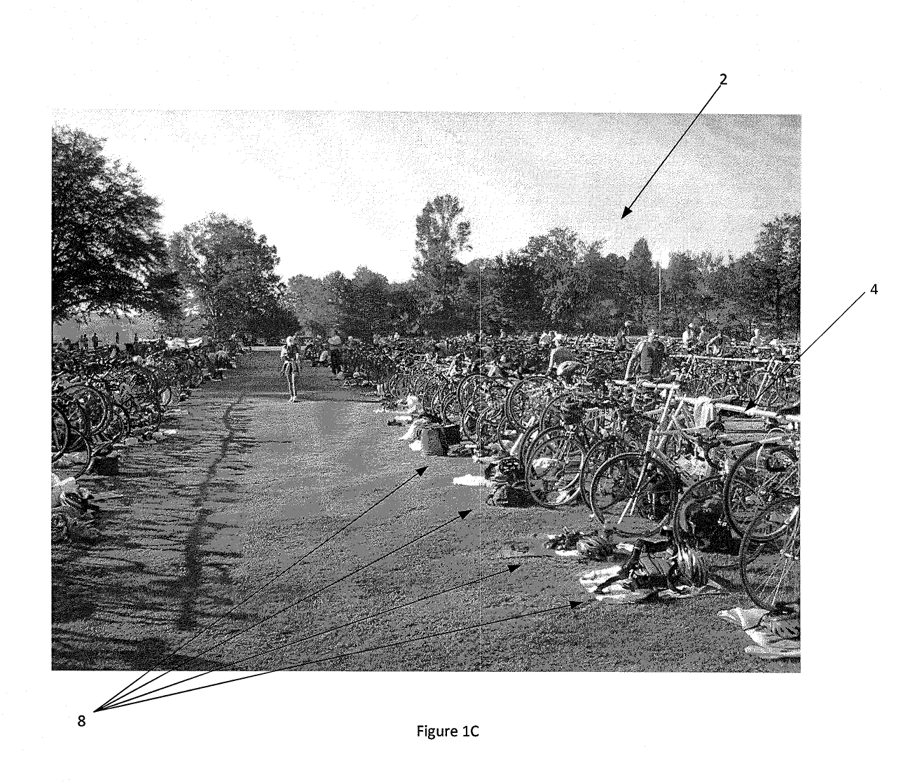

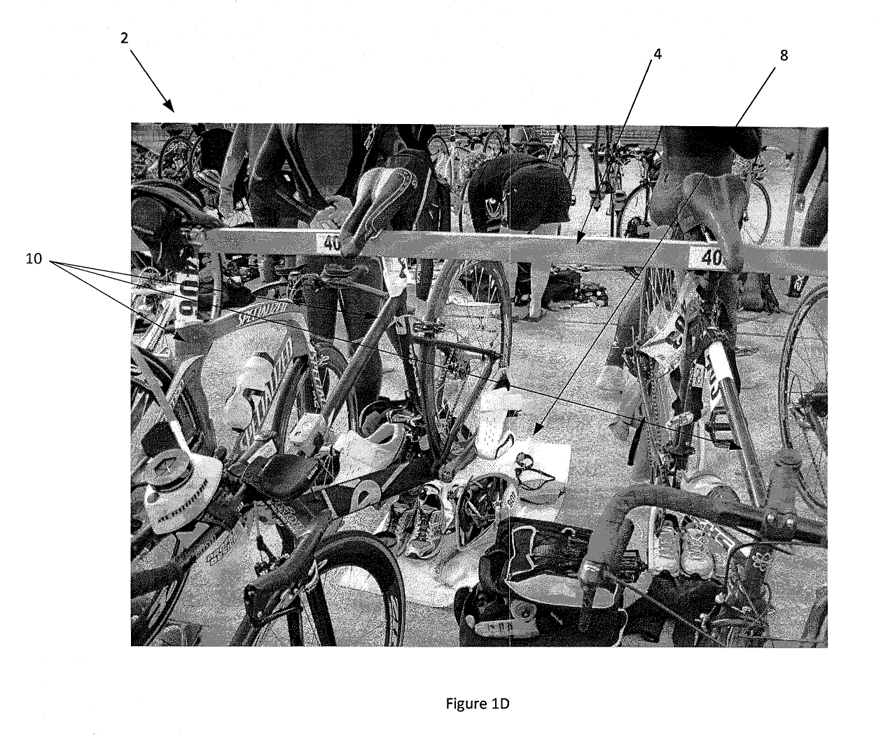

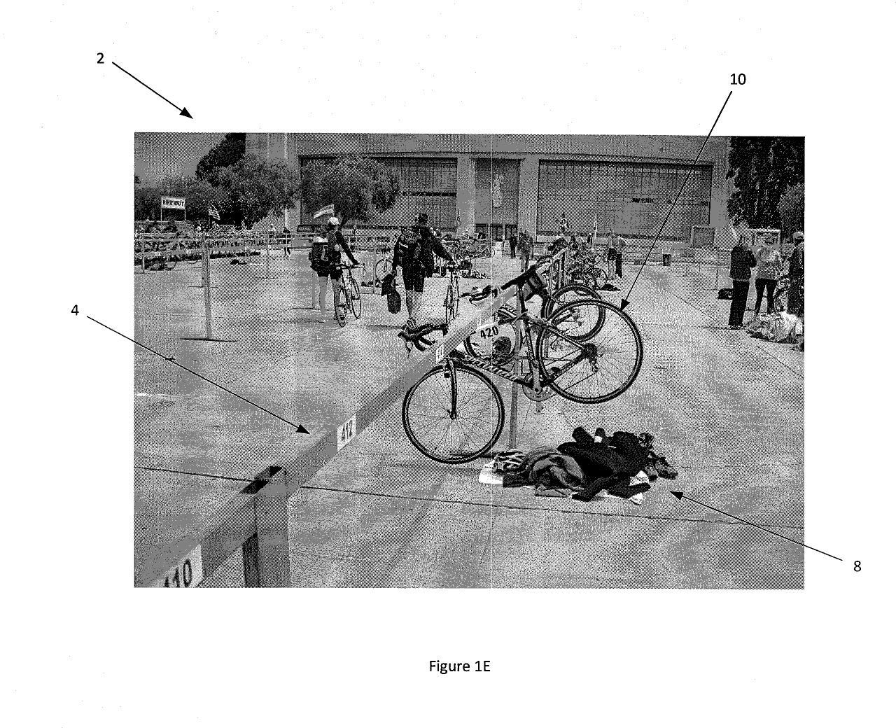

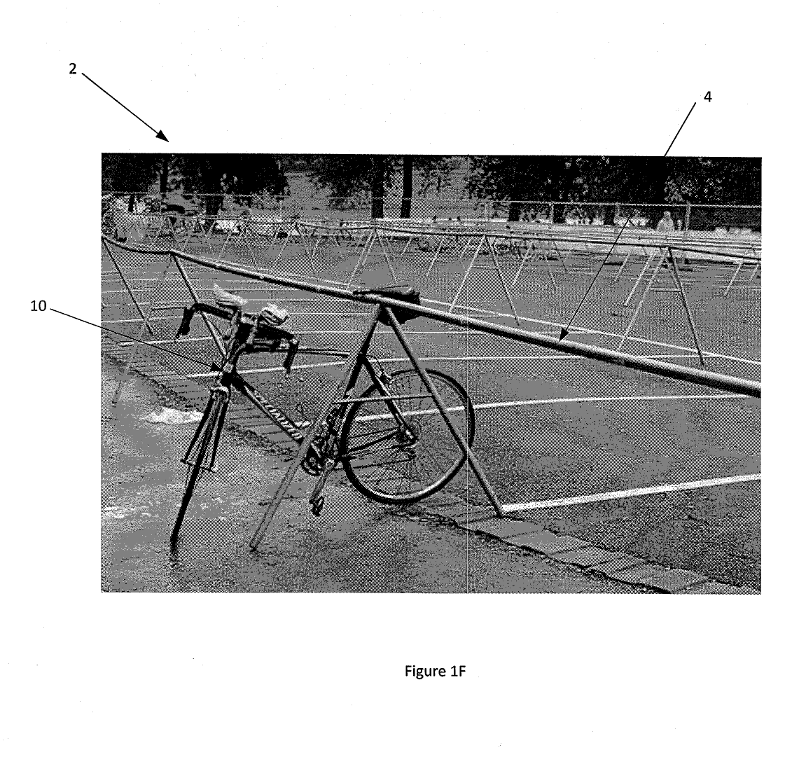

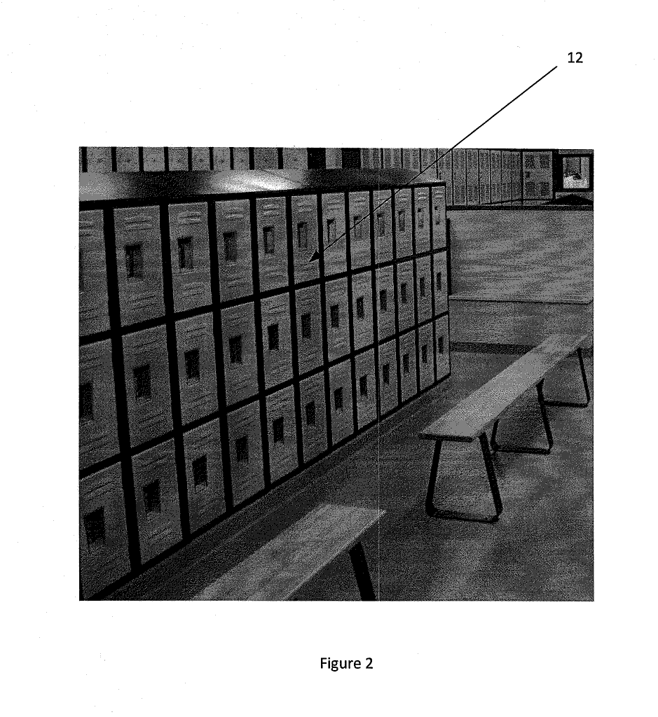

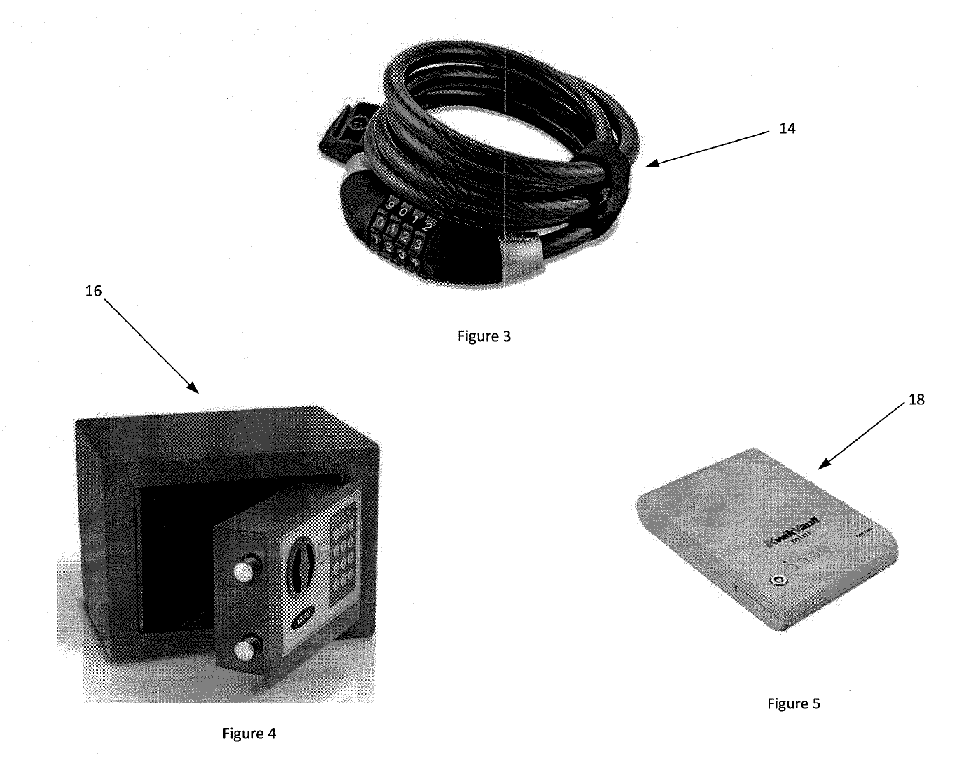

### SUMMARY

One embodiment is directed to a triathlon transition area personal property security apparatus, comprising a locker housing; a locking door movably coupled to the locker housing and comprising a lock configured to lockably close the locking door against the locker housing; and a rack coupling member configured to removably couple the locker housing to a portion of a bicycle rack structure in a manner that substantially retains an orientation of the locking door relative to the bicycle rack structure. The locker housing may comprise a substantially rectangular prismic outer shape profile. The locking door may be rotatably movably coupled to the locker housing. The locking door may be rotatably movably coupled to the locker housing with a rotatable hinge. The lock may comprise a combination lock. The lock may comprise a key-operated lock. The lock may comprise a biometric input device. The biometric input device may comprise a fingerprint reader. The biometric input device may comprise a voice recording element. The biometric input device may comprise an iris imaging element. The rack coupling member may comprise an elongate member with an arcuate portion configured to be positioned around a portion of the bicycle rack. The elongate member may comprise a flexible member. The flexible member may comprise a cable. The flexible member may comprise a plurality of linkage elements movably coupled to one another by movable joints. The elongate member may comprise a distal end configured to loop around the portion of the bicycle rack and recouple to a portion of the housing. The rack coupling member may comprise an adjustable mechanical clamp. The rack coupling member may comprise a second lock configured to lockably couple the housing to the portion of the bicycle rack. The rack coupling member may comprise a second movable joint configured to allow for selective reorientation of the housing relative to the portion of the bicycle rack. The second movable joint may be selectively lockable in a selected orientation. The second movable joint may be selectively lockable in a selected orientation with an intercoupled manual locking engagement element. The rack coupling member further may comprise a third movable joint configured to allow for additional selective reorientation of the housing relative to the portion of the bicycle rack. The third movable joint may be selectively lockable in a selected orientation. The third movable joint may be selectively lockable in a selected orientation with an intercoupled manual locking engagement element. The second and third movable joints may be intercoupled via a joint coupling member interposed between said movable joints.

### DETAILED DESCRIPTION

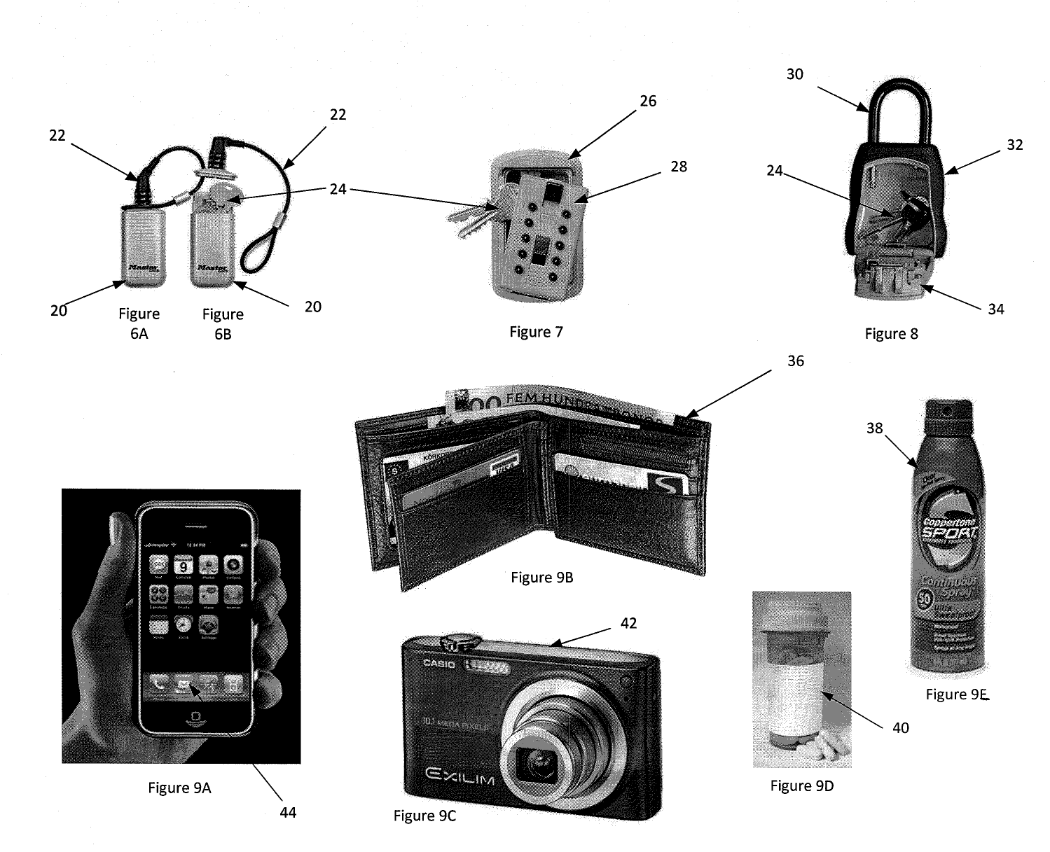

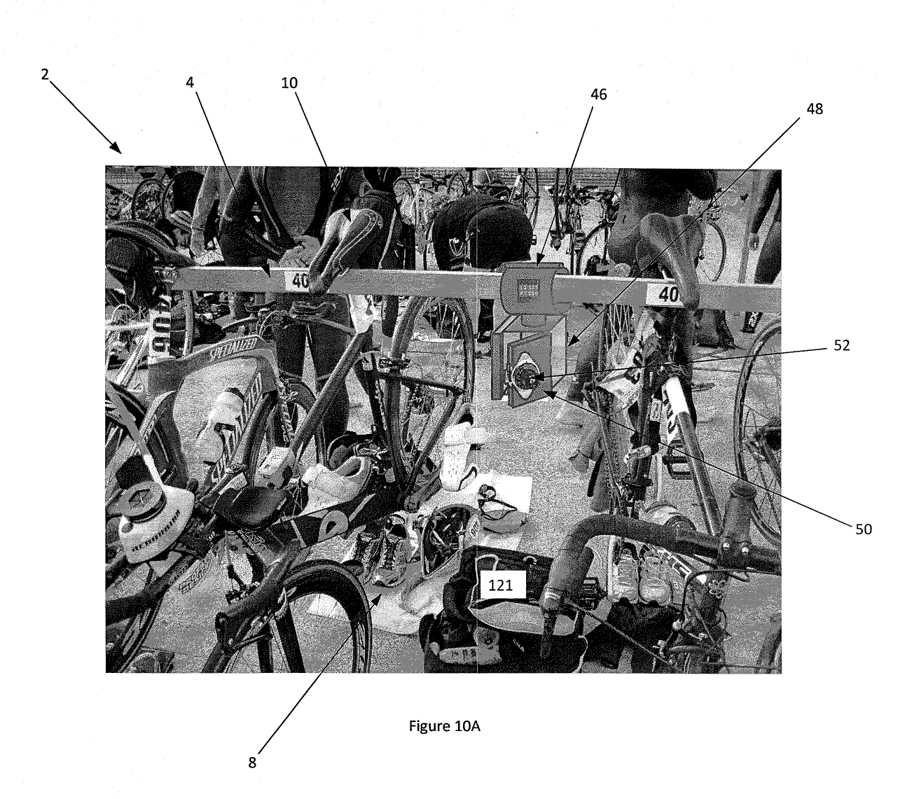

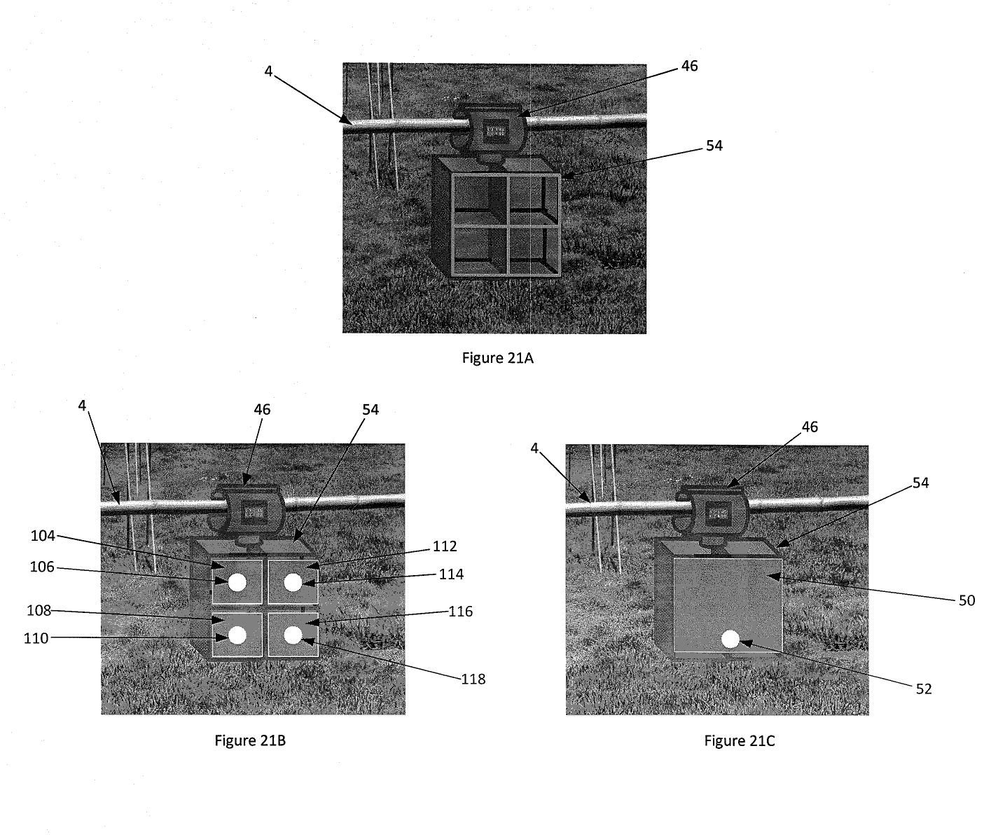

Referring to FIG. 10A, a triathlon transition area (2) is shown with a portable locker coupled to the bike rack horizontal bar (4). The locker comprises a housing (48), a closeable door (50), and a locking mechanism (52) that may be utilized to lock the door shut. The housing is removably coupled to the horizontal bar with a bar coupler (46), such as one of those described in further detail below. Preferably the enclosure volume inside of the locker is large enough to accommodate personal items such as those depicted in FIGS. 9A-9E, and in one embodiment, a water-tight seal is formed when the door (50) is locked into place against the housing (48), by virtue of a rubberized (for example, with silicone seals) perimetric coupling between the two, to enable the athlete to leave electronics and other valuables in the locker even on a rainy day. In one embodiment, the locker housing is between about 6 and about 12 inches wide, between about 6 and 12 inches deep, and between about 8 and about 24 inches in height. This kind of dimensioning fits well within the athlete's transition area space, as shown in FIG. 10A, and also in FIG. 10B, wherein two lockers are shown for two adjacently placed athletes. Referring to FIG. 10C, in one embodiment, the locker housing may comprise a multi-compartment housing (54), which may be fitted either with a single door for a single user, as shown, for example, in FIG. 21C, or with multiple doors for multiple adjacent users, as in the embodiment of FIG. 21B. Such embodiments are described further below in reference to FIGS. 21B and 21C.

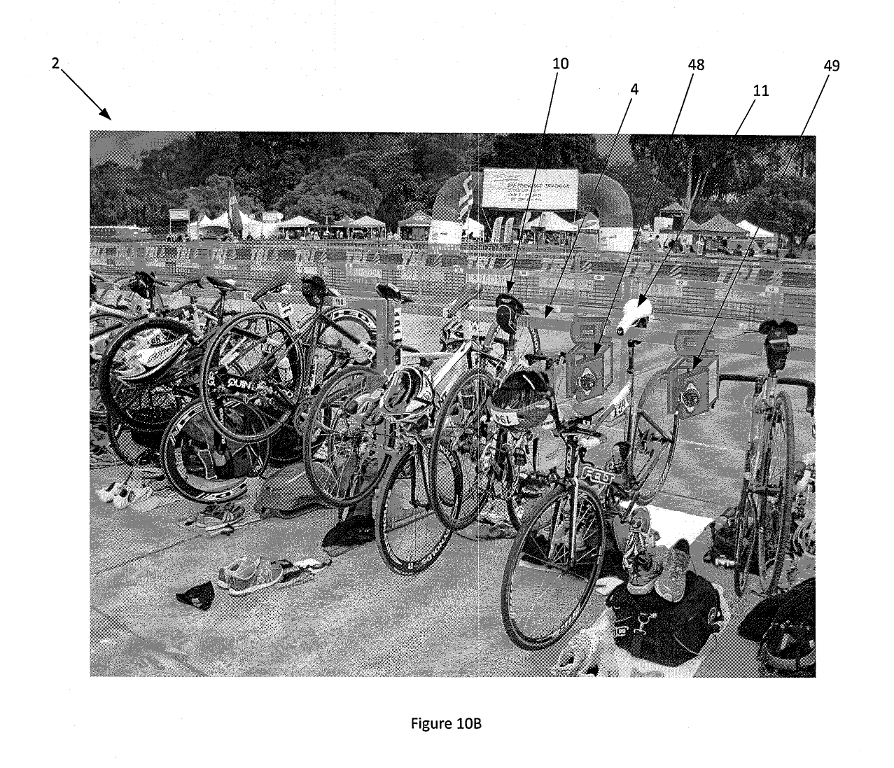

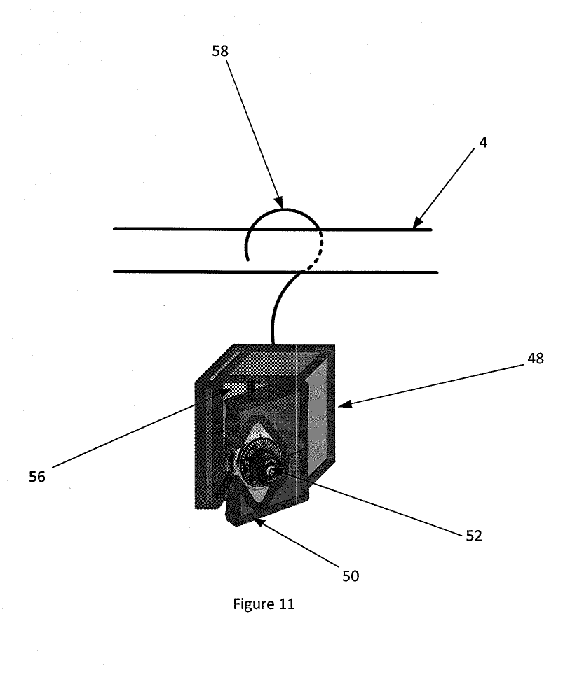

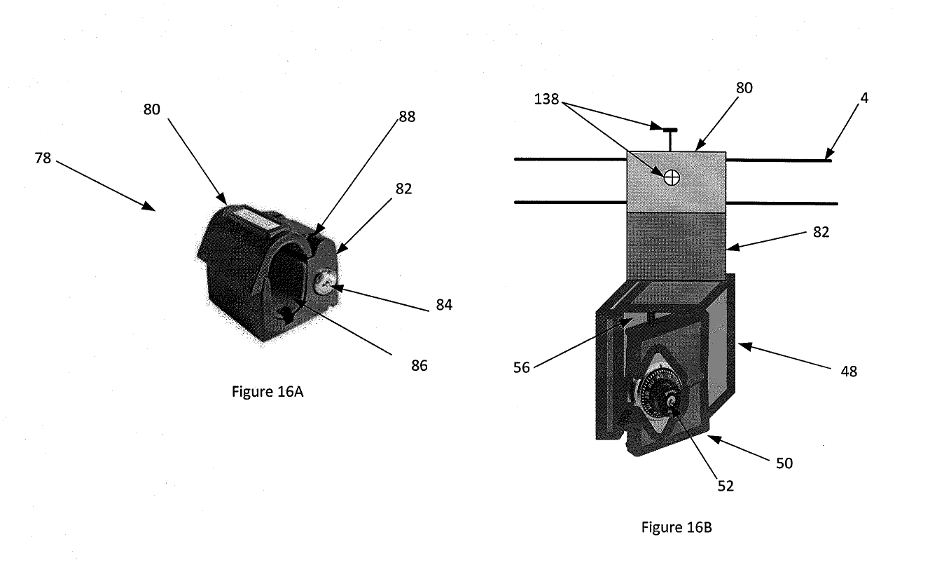

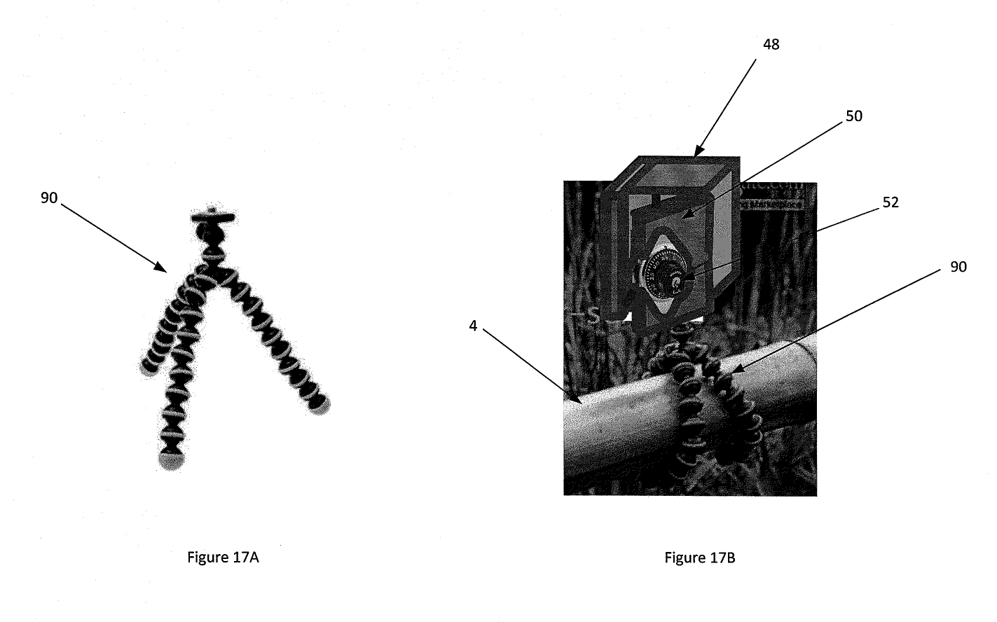

Referring to FIG. 11, in one embodiment, under the questionable assumption that some minimal level of security is required as a deterrent, and that a criminal is not likely to walk off with a locked locker, the locker housing (48) may be removably coupled to the horizontal bar (4) with a very simple mechanical coupling such as a hook member (58). With such a configuration, the personal items may be locked within the door (50) and housing (48), out of view from nearby persons. This is seen as a relatively low-security version, but is somewhat convenient for its simplicity. Another similar embodiment is depicted in FIGS. 17B, 18B, 19B, and 20B, wherein a multi-element articulating assembly (90) such as that depicted in FIG. 17A may be used to couple a locker to a horizontal bike racking bar (4) without a locking mechanism. Referring ahead to FIG. 13, a ratcheting coupler (64) comprising a buckle member (66), ratchet tightening lever (68), and ring member (70) may be utilized to couple a locker to a horizontal bar of various geometries without a lock. In situations wherein an unlocked coupling between the locker and horizontal bike racking bar (4) is deemed inadequate, in a preferred embodiment, the locker may be affirmatively locked to the horizontal bike racking bar (4), as in the variations depicted in FIGS. 10A-10C, 12, 15, 16B, 18A, 19A, 20A, and 21A-21C. Referring back to FIGS. 10A-10C, a combination locking mechanism with combination selection push buttons is configured to allow controlled unlocking of the bar coupler (46), which may be a hinged configuration as shown in FIG. 16A.

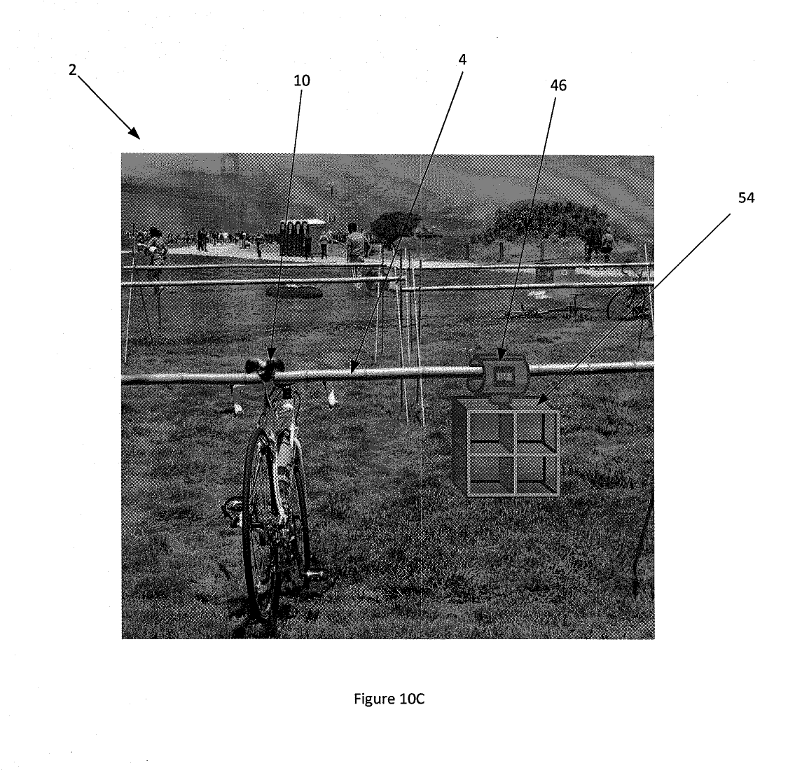

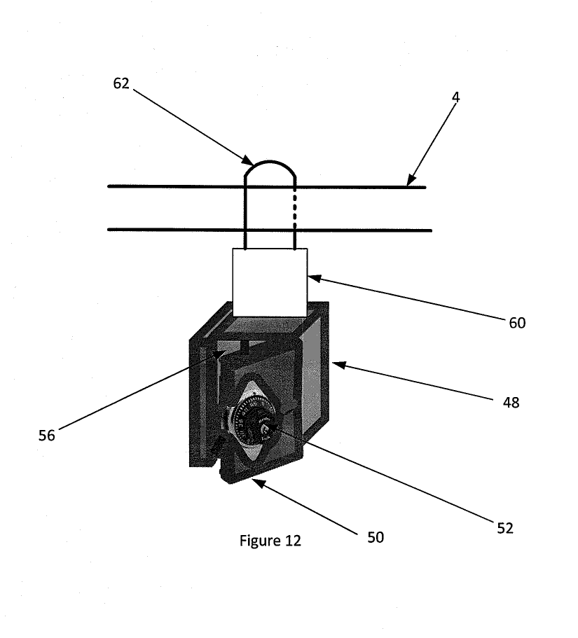

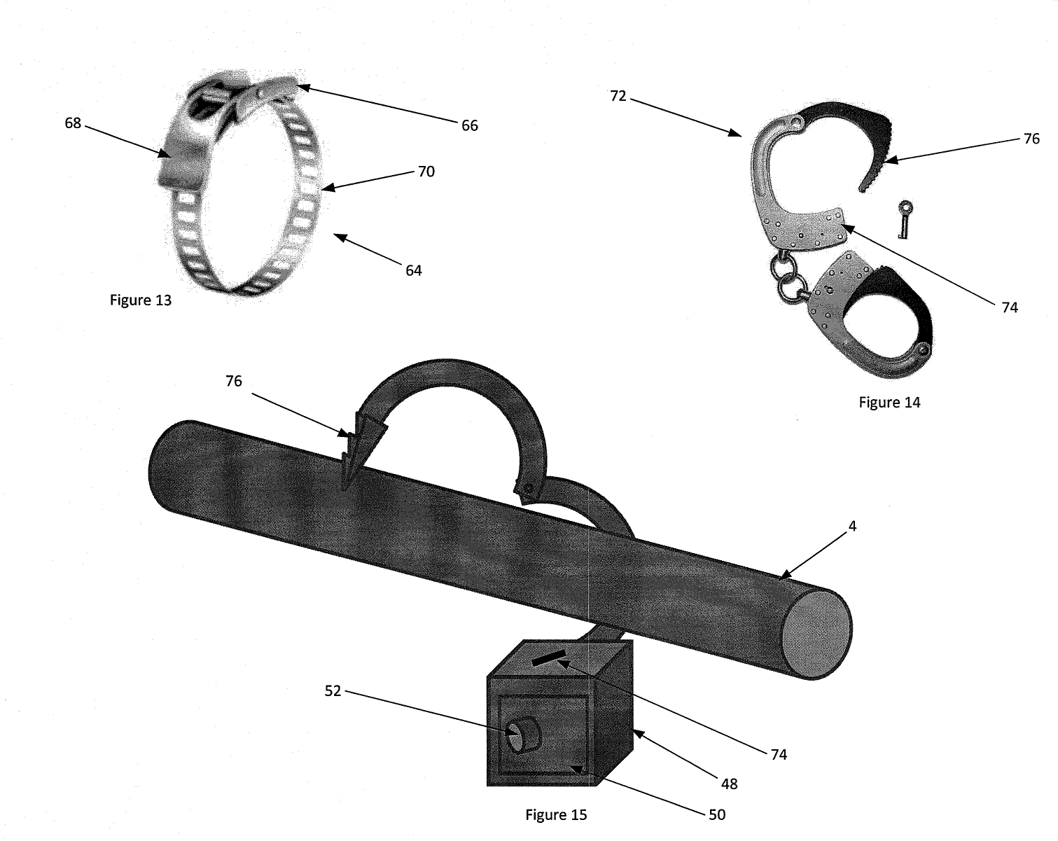

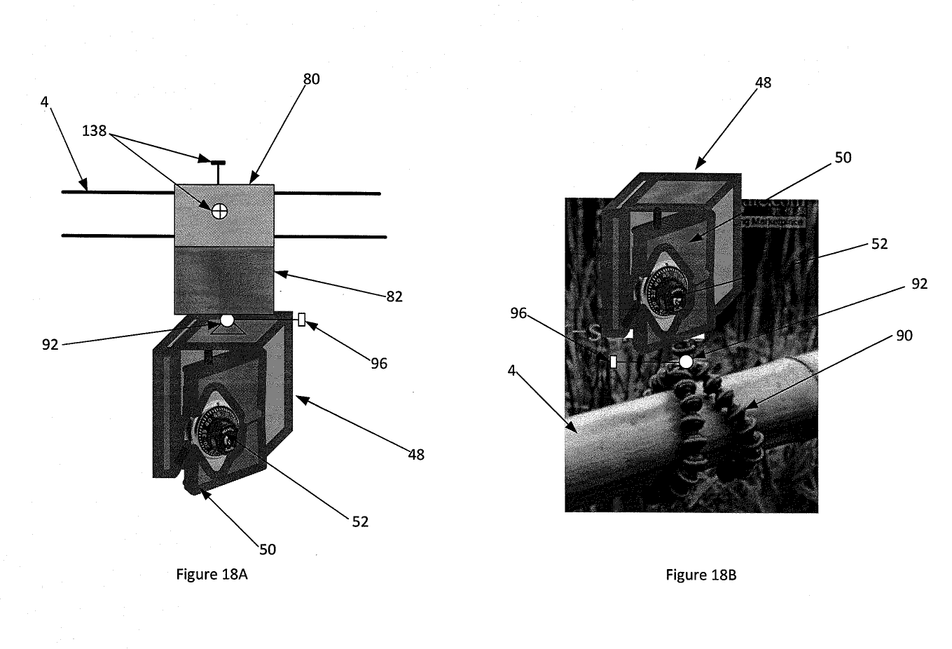

Referring to FIG. 12, in one embodiment, a lock housing may be intercoupled between the locker housing (48) and a movable lock member (62) configured to accommodate most triathlon transition area horizontal bike racking bar (4) sizes. Such a configuration allows the athlete to securely lock his personal items in his transition area without concern that they will be removed, or that the locker itself will be removed. Such as configuration will not, however, allow for preferably and adjustably orienting the locker relative to the aisle of the transition area where the athlete would likely be standing, as in the embodiments of FIGS. 18A-18B, 19A-19B, and 20A-20B. In other words, the embodiments of FIGS. 11 and 12 are configured to allow the user to hang the locker on the horizontal bar without a lot of control regarding preferred orientation of the locker relative to the bar or transition area aisle. Similarly, the embodiment of FIG. 15 features a handcuff style coupling of a receiver (74) and a movable arm with ratchet teeth (76) that may be lockably coupled around the horizontal bike racking bar (4) to allow for solid security, but not maintainable orientation adjustment. FIG. 14 illustrates a conventional handcuff style coupling (72) with a receiver member (74) and a movable arm with ratchet teeth (76).

Referring to FIG. 16A, a clamp type bar coupler (78) comprises a swinging door component (80) rotatably coupled by a hinge (88) to a base component (82) which preferably contains a locking mechanism (84) configured to controllably allow the hinge to let the door component (80) rotate or not. The interior of the coupler (86) defines a capturing geometry that may have a circular, elliptical, rectangular, square, or other cross sectional shape; the depicted embodiment has a rectangular shape with rounded corners, which is useful to accommodate most, if not all, of the bike racking horizontal bar configurations utilized in triathlon transition areas. The interior of the capturing geometry may be lined with a gripping surface such as a rubberized surface. Referring to FIG. 16B, such a clamp type bar coupler may be coupled to a locker to provide for a locker system which is securely lockable to the horizontal bar (4). In the depicted embodiment, adjustment knob—set screw assemblies (138) may be utilized to fine tune the coupling to prevent motion between the coupler and the horizontal bar. In other words, after closing the coupler around the horizontal bar, the adjustment knob—set screw assemblies (138) may be tightened to prevent relative motion between the locker and horizontal bar by advancing distal portions of the screws (138) or small load deconcentrating members coupled to the screws, into the capturing geometry (i.e., they protrude, or intrude, into any free space between the captured bar and the clamp housing) and against the captured horizontal bar. In one embodiment, two or more adjustment knob—set screw assemblies (138) are coupled to a movable fixing member, such as a saddle-shaped structure that defines a portion of the capture geometry, and in operation, after the horizontal bike racking bar has been captured within the clamp type bar coupler, the screw assemblies (138) may be tightened, thereby advancing the movable fixing member against the captured horizontal bike racking bar to provide for stable fixation (until they are later retracted to remove the clamp from the horizontal bar). In such an embodiment, the surface of the movable fixing member may comprise an anti-slip material (such as high-grip rubberized material) or surface geometry (such as a sandpaper, sawtooth, or knurled surface) configured to assist in retaining a firm grip between the clamping configuration and the horizontal bike racking bar. The saddle shape may be desired for the movable fixing member because it can be utilized to improve the fixation of the clamp with horizontal bike racking bar members of various cross sectional geometries or materials, including circular, elliptical, rectangular, or square cross sectional bars. Other suitable shapes for movable fixing members include rectangular prisms, triangular prisms, and the like. One, two, three, or more screws (138) may be intercoupled with the clamp housing and movable fixing members in various configurations. The depicted embodiments show two screws (138), without movable fixing members coupled thereto, that are directed into the capture volume at substantially orthogonal approaches—to provide for set screw type fixation somewhat akin to that provided by a conventional Christmas Tree stand base).

FIG. 17B depicts an embodiment wherein a multielement articulating assembly (90) may be utilized to removably couple the locker to the horizontal bar, and to provide some adjustability of orientation pose of the locker relative to the horizontal bar and transition area aisle given the many degrees of freedom of the multielement articulating assembly (90).

Referring to FIGS. 18A and 18B, configurations similar to those depicted in FIGS. 16B and 17B, respectively, are shown, with the exception that each has an fixable joint (92) interposed between the horizontal bar (4) coupling configuration and the locker housing. Each of the depicted joints (92) may be manually converted from a free moving configuration, wherein the joint may be rotated, to a fixed configuration, wherein the joint is prevented from rotation, by rotation of a simple screw-based joint braking mechanism (96). With such a configuration, the user can get the locker into a preferred orientation with the joint in the free moving configuration, and then tighten the braking mechanism (96) to retain the selected pose. For example, in one scenario, it may be highly desirable for the athlete to have the door directly facing the triathlon transition area aisle and poised to not interfere with his neighbor's bike, or his bike, so he can easily open the lock, open the door, and perhaps get to his sunscreen, medicine, or other personal items during the triathlon race when he happens to be in the transition area, a situation that demands efficiency of both time and geometry in view of the small amount of space that a particular athlete generally has in view of his neighbors at the transition area.

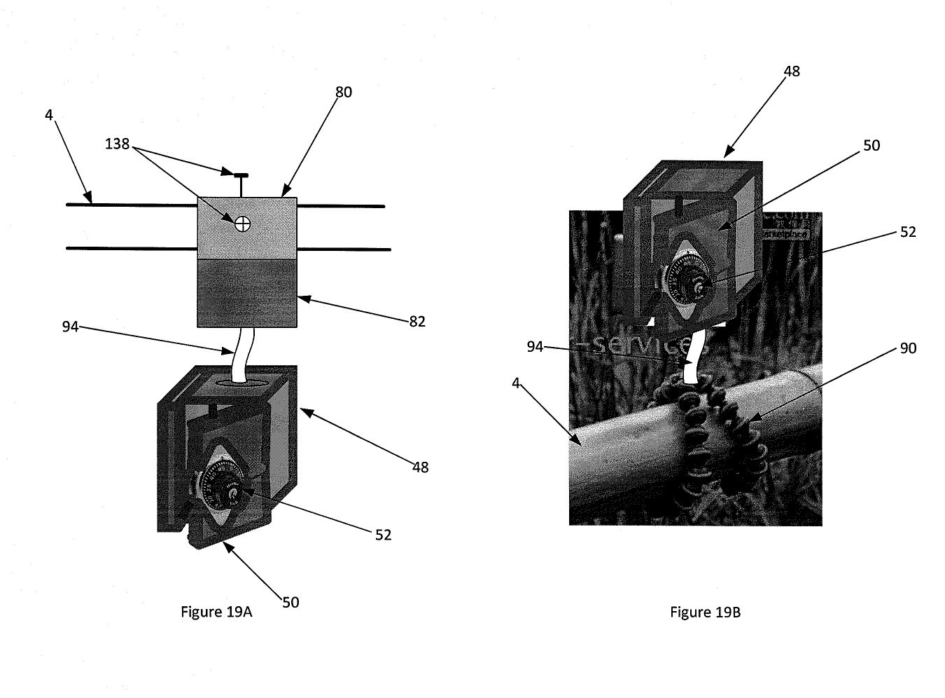

Referring to FIGS. 19A and 19B, embodiments similar to those of FIGS. 18A and 18B are shown, respectively, with the exception that the embodiments of FIGS. 19A and 19B incorporate poseable flex couplings (94) as opposed to lockable joints. The poseable flex couplings (94) may comprise material that is elastically deformable enough to be moved by a user, but also stiff enough to retain a given pose once the user stops applying a load (for example, a lead or other malleable material based configuration), or may comprise assemblies such as those that comprise the aforementioned multielement articulating assembly (90).

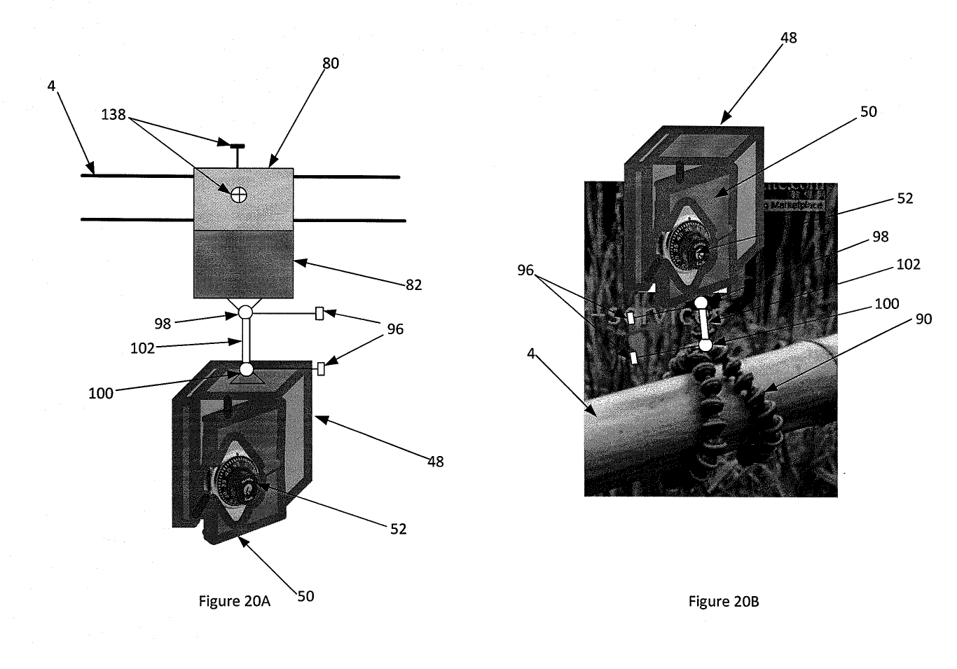

Referring to FIGS. 20A and 20B, embodiments similar to those of FIGS. 18A and 18B are shown, respectively, with the exception that the embodiments of FIGS. 20A and 20B incorporate two-jointed couplings comprising a rigid coupling member (102) intercoupled between first and second joints (98, 100), which in one embodiment may be controllably braked joints, as described above, which may be locked by rotating a control shaft (96). Such configurations provide even greater control over the pose, orientation, and position of the locker relative to the horizontal bike racking bar (4), and relative to the triathlon transition area aisle, where the athlete is likely to be standing.

Referring to FIG. 21A, a multi-compartment housing configuration is shown (54) without a door, as in FIG. 10C. Referring to FIG. 21B, each subcompartment of the multi-compartment housing configuration (54) may be fitted with a unique lock and door (104, 106; 108, 110; 112, 114; 116, 118) to allow four adjacently positioned athletes to share the same locker. Referring to FIG. 21C, a single door (50) and lock (52) may be fitted to the multi-compartment housing configuration (54) to provide a single user with access to all four subcompartments.

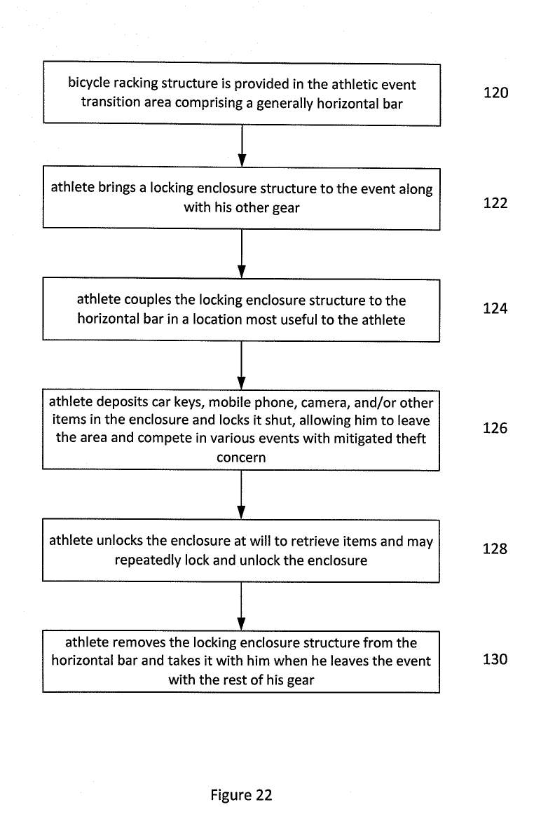

Referring to FIGS. 22-24, several variations of use configurations are illustrated.

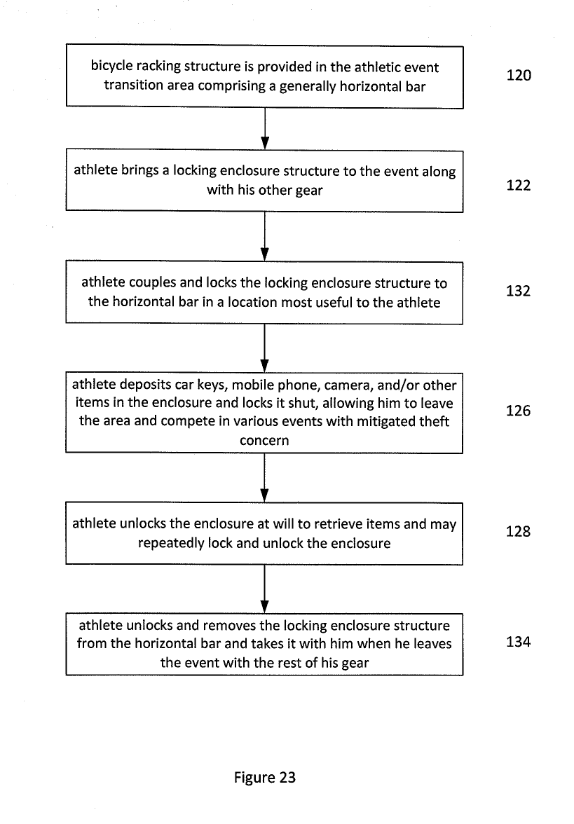

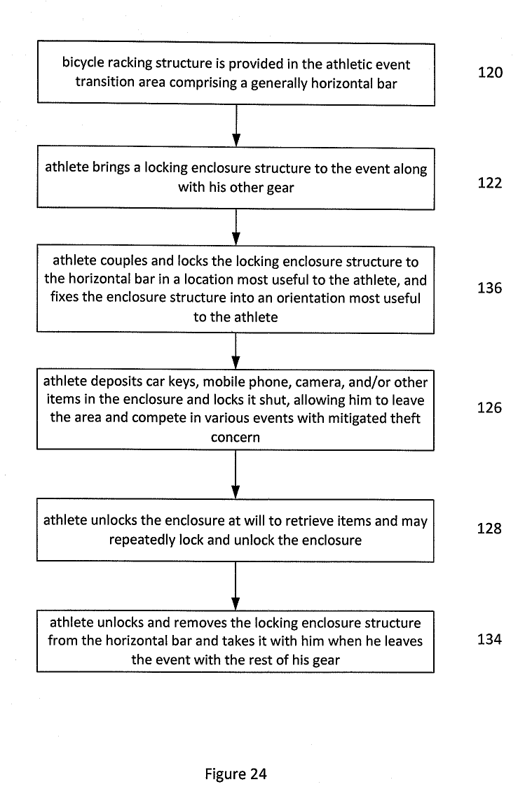

Referring to FIG. 22, a bicycle racking structure is provided in the transition area comprising a generally horizontal bar (120). The athlete brings a locking enclosure structure (i.e., a locker) to the event along with his other gear (122). The athlete couples the locker to the horizontal bar in a location most useful to the athlete (124). The athlete deposits his personal items (keys, camera, cellphone, etc) in the enclosure and locks it shut (126). The athlete unlocks the enclosure at will (for example, before, during, and/or after the race) and may re-lock it (128). When ready to leave, the athlete removes the locking structure from the horizontal bar and takes it away with him (130). Referring to FIG. 23, an embodiment similar to that depicted in FIG. 22 is shown, with the exception that after step 122, the athlete both couples, and also locks, the locker to the horizontal bar (132). Subsequently, when it is time to leave, the athlete unlocks the locker from the horizontal bar (134). Referring to FIG. 24, a configuration similar to that of FIG. 23 is illustrated, with the exception that after step 122, the athlete not only couples and locks the locker to the horizontal bar, but also fixes the locker in a position and/or orientation most useful to the athlete (136), which may utilize, for example, one of the embodiments described above with adjustable posing hardware.

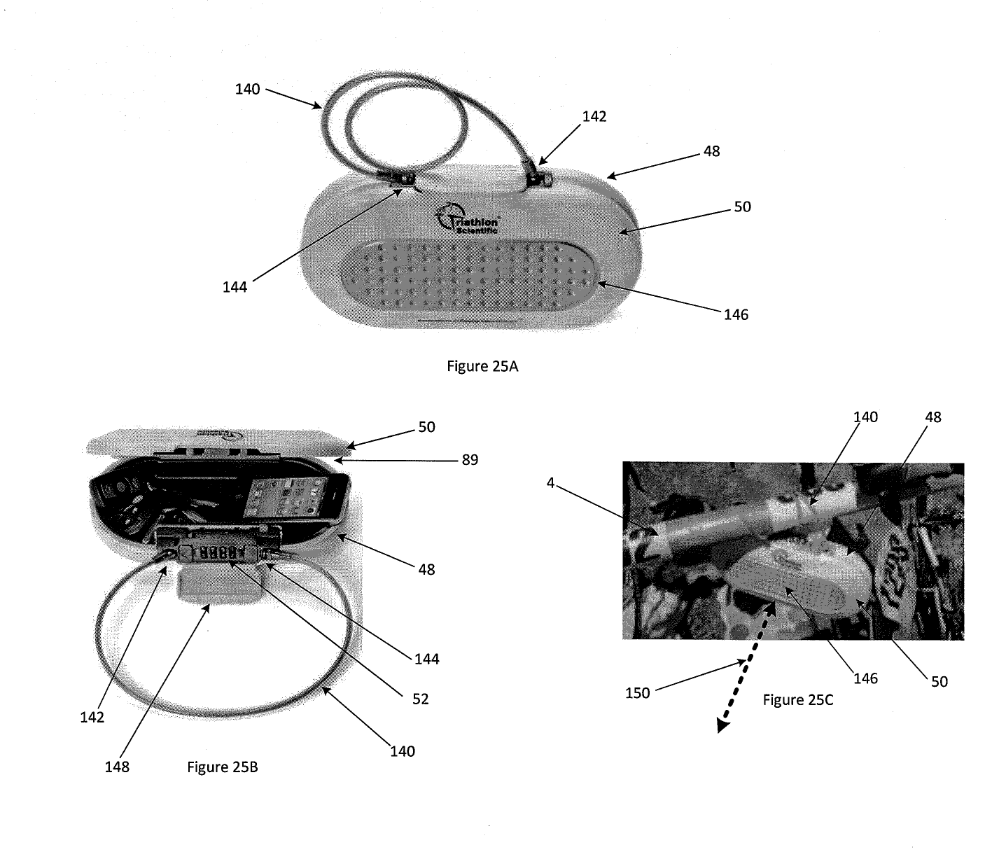

Referring to FIGS. 25A-25C, a lightweight transition area locker embodiment is depicted wherein a door (50) is rotatably coupled to a housing (48) with a hinge (89) style movably coupling. Two ends of a cable (140) are coupled to the housing (48) at a lock (52) interface. In one embodiment, a first end (142) of the cable is permanently coupled to the housing (48) while a second end (144) is removably coupled (removable via release of the associated lock 52) so that it may be looped or wrapped around a nearby structure to which the locker is to be coupled, such as a horizontal bicycle rack bar (4) of a triathlon transition area. In another embodiment, both ends (142, 144) may be removed with unlocking of the lock (52). A lock interface cover (148) may be movably coupled to the housing (48) and/or lock (52) to protect the lock from weather exposure; the depicted embodiment of the cover (148) swings out of the way like a small door when an athlete desires to access the lock (52). The depicted embodiment features a utility surface (146) which may be utilized for various purposes before the athletic event, such as for assembling food consumables before the locker has been coupled to the rack (i.e., in a role somewhat akin to a cutting board—to keep the food items off of the nearby substrate surface, which may very well be the ground in a triathlon transition area). In another embodiment, the utility surface (146) may comprise a reflective mirror which may provide a key role in a triathlon race transition: assistance with quickly applying sun protective lotion when at the transition area, such as in the transition from a swim event to a cycling event, when it commonly is a desire of athletes to very quickly apply sun protection once a wetsuit or other swim clothing has been removed for the transition to cycling. With a mirror in the transition area, and particularly with a mirror in a pose or orientation relative to the athlete's assigned transition area spot, the athlete can quickly (again, time is of the essence in a race) look over and utilize the mirror in a hands-free manner while he is switching clothing, applying sun protection, etc. FIG. 25C depicts a locker coupled to a transition area bike rack member (4) with the cable (140) in a preferred pose or orientation relative to the athlete (illustrated by the depicted orientation axis relative to the athlete's transition area position 150) to allow the athlete to use a mirror which may comprise or be coupled to the utility surface (146) of the locker. Such a mirror configuration may also be featured in any of the aforementioned configurations, such as those described in reference to FIGS. 10A-12, 15, 16B, 17B, 18A-21C, which have one or more flat sides that are well suited for a reflective mirror surface. The movable and/or lockable joints of the embodiments of FIGS. 17B, 18A-B, 20A-B, and the flexible segment of the embodiments of FIGS. 19A-B are particularly useful in assisting the athlete to establish a desired pose or orientation of one or more surfaces of the locker to his position in the transition area.

While most of the embodiments described above have featured combination style locks wherein an operator may manually manipulate one or more combination input controls (such as a dial or wheel), pushbutton digital locks may be utilized, as well as keyed locks, and biometric locks such as those which comprise a biometric input device and a microcontroller or processor (as well as an associated power supply, such as a battery) to assist in operating the input device and processing the input. For example, in one embodiment, a biometric input device for a locker configuration may comprise a fingerprint reader, a voice recorder (or voice recording element such as a microphone), or an eye iris scanner. Such technologies are well known and are presently featured on devices such as laptop computers to bypass manual password entry with a keyboard; they typically also are accompanied with a small storage device such as a memory chip so that the processor may examine a stored sampling of the biometric information. With such a configuration, an athlete can race into the transition area, swipe his thumb on the fingerprint scanner very quickly (or in the case of an iris scanner, put his eye nearby to the reader, or in the case of a voice recorder, speak toward the locker) to unlock the locker, grab something out of his locker and/or put something in, such as a medication, nutritional element, specialized prescription cycling glasses, or specialized timing device, close the locker, and use the utility surface as a mirror to quickly apply sun protection before he races away on his bicycle. In such an embodiment, the biometric input device or reader may save valuable seconds over a conventional combination lock input device, and may be more secure.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject systems and devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A triathlon transition area personal property security apparatus, comprising:
a. a locker housing;
b. a locking door movably coupled to the locker housing and comprising a lock configured to lockably close the locking door against the locker housing; and
c. a rack coupling member configured to removably couple the locker housing to a portion of a bicycle rack structure in a manner that substantially retains an orientation of the locking door relative to the bicycle rack structure.

2. The apparatus of claim 1, wherein the locker housing comprises a substantially rectangular prismic outer shape profile.

3. The apparatus of claim 1, wherein the locking door is rotatably movably coupled to the locker housing.

4. The apparatus of claim 3, wherein the locking door is rotatably movably coupled to the locker housing with a rotatable hinge.

5. The apparatus of claim 1, wherein the lock comprises a combination lock.

6. The apparatus of claim 1, wherein the lock comprises a key-operated lock.

7. The apparatus of claim 1, wherein the lock comprises a biometric input device.

8. The apparatus of claim 7, wherein the biometric input device comprises a fingerprint reader.

9. The apparatus of claim 7, wherein the biometric input device comprises a voice recording element.

10. The apparatus of claim 7, wherein the biometric input device comprises an iris imaging element.

11. The apparatus of claim 1, wherein the rack coupling member comprises an elongate member with an arcuate portion configured to be positioned around a portion of the bicycle rack.

12. The apparatus of claim 11, wherein the elongate member comprises a flexible member.

13. The apparatus of claim 12, wherein the flexible member comprises a cable.

14. The apparatus of claim 12, wherein the flexible member comprises a plurality of linkage elements movably coupled to one another by movable joints.

15. The apparatus of claim 11, wherein the elongate member comprises a distal end configured to loop around the portion of the bicycle rack and recouple to a portion of the housing.

16. The apparatus of claim 1, wherein the rack coupling member comprises an adjustable mechanical clamp.

17. The apparatus of claim 1, wherein the rack coupling member comprises a second lock configured to lockably couple the housing to the portion of the bicycle rack.

18. The apparatus of claim 1, wherein the rack coupling member comprises a second movable joint configured to allow for selective reorientation of the housing relative to the portion of the bicycle rack.

19. The apparatus of claim 18, wherein the second movable joint is selectively lockable in a selected orientation.

20. The apparatus of claim 19, wherein the second movable joint is selectively lockable in a selected orientation with an intercoupled manual locking engagement element.

21. The apparatus of claim 18, wherein the rack coupling member further comprises a third movable joint configured to allow for additional selective reorientation of the housing relative to the portion of the bicycle rack.

22. The apparatus of claim 21, wherein the third movable joint is selectively lockable in a selected orientation.

23. The apparatus of claim 22, wherein the third movable joint is selectively lockable in a selected orientation with an intercoupled manual locking engagement element.

24. The apparatus of claim 21, wherein the second and third movable joints are intercoupled via a joint coupling member interposed between said movable joints.
